(19) United States
(12) Patent Application Publication
(10) Pub. No.: US 2021/0023645 A1
(43) Pub. Date: Jan. 28, 2021

(54) METHOD AND SYSTEM FOR WELDING INCONEL TO STAINLESS STEEL

(71) Applicant: Caterpillar Inc., Deerfield, IL (US)

(72) Inventors: Matthew L. Hoskins, Lacon, IL (US); Matthew J. Behmlander, Metamora, IL (US)

(73) Assignee: Caterpillar Inc., Deerfield, IL (US)

(21) Appl. No.: 16/519,453

(22) Filed: Jul. 23, 2019

(51) Int. Cl. B23K 10/02

(52) U.S. Cl. CPC B23K 10/02; B23K 2103/05

(57) ABSTRACT

A method of gas metal arc welding, (GMAW) an Inconel part to a stainless steel part, including forming a weldable joint between a first surface of the Inconel part having a first thickness and a second surface of a stainless steel part having a second thickness at the weldable joint that is greater than the first thickness, welding the Inconel part to the stainless steel part along the weldable joint with the welding torch, delivering an output from the welding power source to the welding torch during welding, wherein the output of the welding power source is in the range of 100 amps to 400 amps and in the range of 14 volts to 30 volts, and delivering a continuous weld wire to a distal tip of the welding torch during welding, wherein a feed rate of the weld wire is in the range of 3 m/min. to 9 m/min.

### TECHNICAL FIELD

This disclosure relates to a method for welding Inconel to stainless steel, and in particular, to a method of using a robotic welder to weld a thin-walled Inconel component to a thicker stainless steel component, such as for example, as part of an EGR cooler.

### BACKGROUND

In internal combustion engines, such as gasoline and diesel fueled engines, exhaust gas recirculation (EGR) is often used to reduce nitrogen oxide (NOx) emissions. EGR works by recirculating a portion of the engine's exhaust gas back to the engine cylinders. EGR systems often include a heat exchanger, commonly referred to as an EGR cooler, to lower the temperature of the exhaust gas being recirculated to the intake of the internal combustion engine.

Lowering the temperature of the recirculated exhaust gas results in lower combustion temperatures, which is a key variable for reducing of NOx formation. EGR coolers are primarily stainless steel, since in the environment where the EGR cooler is located is corrosive and other metals would rust, and rust flakes can result in major damage to the engine. EGR coolers, however, are also subject to significant thermal loading and cycling, which results in high thermal stresses on the EGR coolers and the joints attaching the EGR cooler within the EGR system. Thus, EGR coolers and the joints must resist corrosion and withstand the high thermal loads experienced during operation.

For example, U.S. Patent Publication 2001/0047861, entitled “Brazing Method, Brazement, Method of Production of Corrosion-Resistant Heat Exchanger, and Corrosion-Resistant Heat Exchanger,” discloses a method of producing a corrosion-resistant heat exchanger made of stainless steel. The method includes plating chrome on a first stainless steel plate to form a chrome-based brazing filler metal layer. Then, plating nickel-phosphorus on the chrome-based brazing filler metal layer to form a nickel-based brazing filler metal layer on the chrome-based brazing filler metal layer. Then heating to a temperature of at least the melting point of the nickel-based brazing filler metal layer to braze the first stainless steel plate to a second stainless steel plate with the chrome-based brazing filler metal layer and the nickel-based brazing filler metal layer interposed between the two plates. Due to this, a high corrosion resistance brazing filler metal containing an Ni—Cr28—P8-etc, alloy composition is obtained between the first and second stainless steel plates.

### SUMMARY

In accordance with the present disclosure there is provided a method and system for welding Inconel to stainless steel.

In accordance with one aspect of the present disclosure, a method of GMAW to Inconel part to a stainless steel part, includes forming a weldable joint between a first surface of the Inconel part having a first thickness and a second surface of a stainless steel part having a second thickness at the weldable joint that is greater than the first thickness, welding the Inconel part to the stainless steel part along the weldable joint with the welding torch, delivering an output from the welding power source to the welding torch during welding, wherein the output of the welding power source is in the range of 100 to 400 amps and 14 to 30 volts, and delivering a continuous weld wire to a contact tip of the welding torch during welding, wherein a feed rate of the weld wire is in the range of 3 m/min to 9 m/min.

In accordance with another aspect of the present disclosure, a robotic welding system includes a welding robot having a welding torch and a. weld wire feeder configured to deliver a continuous weld wire to a distal tip of the welding torch during welding, a welding power source in communication with the welding robot to provide a power output to the welding torch and with the weld wire feeder to provide power to the weld wire feeder, and a robot controller in communication with the power source and the welding robot. The robot controller is configured to control the power source to deliver an output to the welding torch, during welding an Inconel part having a first thickness to a stainless steel part having a. second thickness, that is in the range of 100 to 400 amps and 14 to 30 volts, and delivering a continuous weld wire to a contact tip of the welding torch during welding, wherein a feed rate of the weld wire is in the range of 3 m/min to 9 m/min.

In accordance with another aspect of the present disclosure, a method of GMAW an Inconel diffuser to a stainless steel end plate of an EGR cooler using a welding system having a welding power source, includes forming a weldable joint between an end surface of the Inconel diffuser and a peripheral surface of the stainless steel end plate, wherein the Inconel end surface has a first thickness and the steel plate has a second thickness that is greater than the first thickness at the weldable joint, welding the Inconel diffuser to the stainless steel end plate along the weldable joint with the welding torch, delivering an output from the welding power source to the welding torch during welding, wherein the output of the welding power source is in the range of 100 to 400 amps and 14 to 30 volts, and delivering a continuous weld wire to a contact tip of the welding torch during welding, wherein a feed rate of the weld wire is in the range of 3 m/min to 9 m/min.

### BRIEF DESCRIPTION OF THE DRAWINGS

Further features and advantages will be evident from the following illustrative embodiment which will now be described, purely by way of example and without limitation to the scope of the claims, and with reference to the accompanying drawings, in which:

FIG. 1 is an illustration of a side view of welded joint between an Inconel part and a stainless steel part;

FIG. 2 is a schematic view of a robotic welder;

FIG. 3 is a flow chart of an exemplary welding process for welding a thin-walled Inconel component to a thicker stainless steel component, using a robotic welder;

FIG. 4 is a side view of an exemplary embodiment of an EGR cooler; and

FIG. 5 is a partial sectional exploded view of the header and diffuser of the EGR cooler of FIG. 3

### DETAILED. DESCRIPTION

While the present disclosure describes, in detail, certain embodiments of a method for welding a thin-walled Inconel component to a thicker stainless steel component, using a robotic welder, the present disclosure is to be considered exemplary and is not intended to be limited to the disclosed embodiments. Also, certain elements or features of embodiments disclosed herein are not limited to a particular embodiment, but instead apply to all embodiments of the present disclosure.

The terminology as set forth herein is for description of the embodiments only and should not be construed as limiting the disclosure as a whole. All references to singular characteristics or limitations of the. present disclosure shall include the corresponding plural characteristic or limitation, and vice versa. unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, when the phrase “one or more of A and B” is employed it is intended to mean “only A, only B, or both A and B.”

The method and system of the present disclosure can comprise, consist of, or consist essentially of the essential elements of the disclosure as described herein, as well as any additional or optional element or feature described herein or which is otherwise useful in welding applications.

Unless otherwise indicated, all numbers expressing parameters, such as amperage, voltage, rate, or other parameters as used in the specification and claims are to be understood as being modified in all instances by the term “about.” Accordingly, unless otherwise indicated, the numerical properties set forth in the specification and claims are approximations that may vary depending on the suitable properties sought to be obtained in embodiments of the present invention. Notwithstanding that the numerical ranges and parameters setting forth the broad scope of the general inventive concepts are approximations, the numerical values set forth in the specific examples are reported as precisely as possible. Any numerical values, however, inherently contain certain errors necessarily resulting from error found in their respective measurements. general, the term “about” modifies a numerical value above and below the stated value by 10%.

All ranges and parameters, including but not limited to dimensions, percentages and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4). and to each integer (1, 2, 3, 4, 5, 6, 7, 8, 9, and 10) contained within the range.

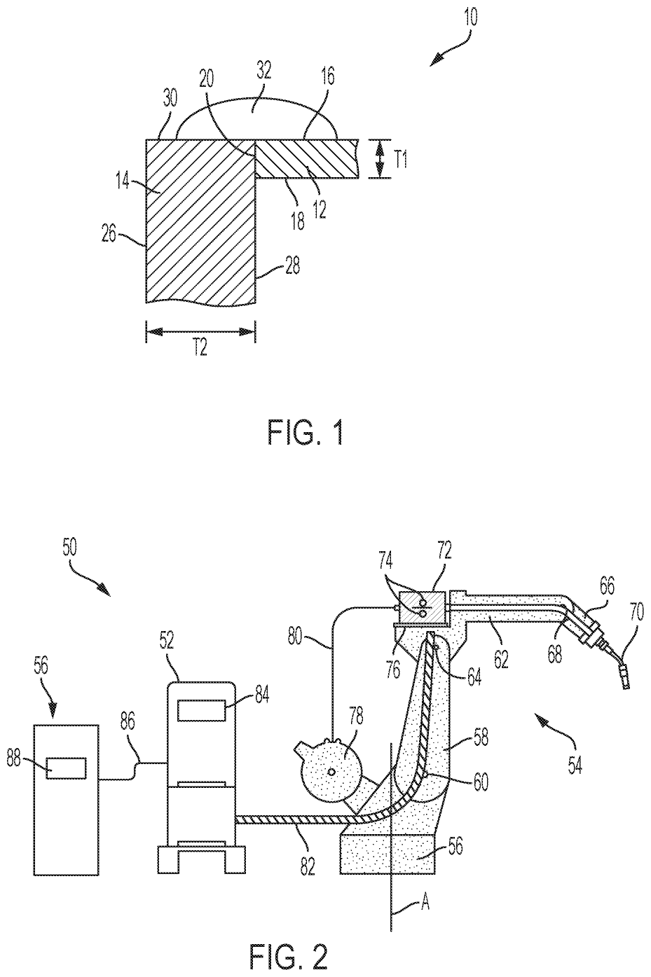

FIG. 1 illustrates an exemplary embodiment of a welded joint 10 between an Inconel part 12 and a stainless steel part 14. As used in this application, “Inconel,” which is a trademark of Special Metals Corporation, refers to the known family of austenitic nickel-chromium-based superalloys that use that tradename. As used in this application, “Inconel 625” refers to an austenitic nickel-chromium-based superalloy having the nominal composition ranges shown in Table 1, below:

TABLE 1

| | Cr | Mo | Co | Nb + Ta | Al | Ti | C | Fe | Mn | Si | P | S | Ni |
|---|---|---|---|---|---|---|---|---|---|---|---|---|---|
| Min, % | 20 | 8 | — | 3.15 | — | — | — | — | — | — | — | — | 58.0 |
| Max, % | 23 | 10 | 1 | 4.15 | 0.4 | 0.4 | 0.1 | 5 | 0.5 | 0.5 | 0.015 | 0.015 | Balance |

Additional common trade names for the superalloy Inconel 625, include: Chronin 625, Altemp 625, Haynes 625 Nickelvac 625, and Nicrofer 6020. All of which are considered the same material for purposes of this specification.

The Inconel part 12 and the stainless steel part 14 may be configured in a variety of ways. In the illustrated embodiment, both the Inconel part 12 and a stainless steel part 14 are depicted as plates. In other embodiments, however, the Inconel part 12 and/or the stainless steel part 14 may he any suitable shape that allows the two parts to be welded together. The Inconel part 12 includes a first side face 16, a second side face 18 opposite and parallel to the first side face 16, and an end face 20 extending perpendicularly between the first side face 16 and the second side face 18. The Inconel part 12 has a first thickness T1. Similarly, the, stainless steel part 14 includes a first side face 26, a second side face 28 opposite and parallel to the first side face 26, and an end face 30 extending perpendicularly between the first side face 26 and the second side face 28. The stainless steel part 14 has a first thickness T2.

In the illustrated embodiment, the end face 20 of the Inconel part abuts, or is adjacent the second side face 28 of the stainless steel part 1.4 while the end face 30 of the stainless steel part 14 is coplanar, or nearly coplanar, with the first side face 16 of the Inconel part 12. The Inconel part 12 and the stainless steel part 14 are welded in the position such that a weld bead 32 is formed over the interface between the end face 30 of the stainless steel part 14 and the first side face 16 of the Inconel part 12. Thus, the welded joint 10 may be characterized as a butt joint. In will be understood, however, that in other embodiments, the Inconel part 12 and the stainless steel part 14 may be configured and arranged such that the welded joint is any suitable type of welded joint, such as for example, a corner joint, an edge joint, a lap joint, a tee joint, or other type of weld joint.

Further, in the illustrated embodiment, the end face 20 of the Inconel part 12 and the second side face 28 of the stainless steel part 14 are flat and parallel to each other at the weld to form a single square groove. In other embodiments, however, one or more of the end face 20 of the Inconel part 12 and the second side face 28 of the stainless steel part 14 may he configured other than flat and parallel to the other face. For example, the weld joint may be a single bevel groove, double bevel groove, single-J groove, double-J groove, single-U groove, double-U groove, single-V groove, double-V groove, flanged groove, flare groove (such as a flare bevel or flare-V groove), or any suitable groove configuration.

The type of Inconel alloy and the type of stainless steel alloy used for the Inconel part 12 and the stainless steel part 14, respectively, may vary in different embodiments. In the illustrated embodiment, the Inconel part 12 is made from Inconel 625 alloy and the stainless steel part 14 is made from stainless steel alloy 316. For the purpose of this disclosure, the welding procedure parameters are configured for joining a thin Inconel 625 part to a thicker stainless steel 316 part.

The Inconel part thickness T1 and the stainless steel part thickness T2 may vary in different embodiments. In the illustrated embodiment, the Inconel part thickness T1 is less than the stainless steel part thickness T2. For example, in sonic embodiments, the Inconel part thickness T1 is 50% or less than the stainless steel part thickness T2, is 40% or less than the stainless steel part thickness T2, is 35% or less than the stainless steel part thickness T2, or is 30% or less than the stainless steel part thickness T2. In one exemplary embodiment, the thickness of the stainless steel part 14 is in the range of 3 mm to 5 mm and the thickness of the Inconel part is in the range of 30% to 40% of the thickness of the stainless steel part.

Referring to FIG. 2, an exemplary embodiment of a welding system 50 for welding the Inconel part 12 to the stainless steel part 14 is illustrated. The welding system 50 may be any suitable welding system capable of welding a thin Inconel part to a thicker stainless steel part. In the illustrated embodiment, the welding system 50 is a robot-based, gas metal arc welding (GMAW) system programmed with specific welding parameters for joining a thin Inconel 625 alloy part to a thicker stainless steel 316 alloy part, as discussed in more detail below. GMAW is an arc welding process in which a continuous solid weld wire electrode is fed through a welding torch/gun and into a weld pool formed between the components being welded, joining the two base materials together. It will be, understood that the illustrated robot-based welding system 50 may have a variety of configurations. The specific components discussed below in relation to FIG. 2 are exemplary in nature. A person of ordinary skill in the art will appreciate that robot-based welding system 50 may have additional components or fewer components than illustrated.

The welding system 50 includes a welding power source 52, a welding robot 54, and a robot controller 56. The welding power source 52 may be any suitable power source configured to provide the necessary power to generate the heat to liquefy the Inconel and stainless steel so that the Inconel part 12 and the stainless steel part 14 are welded together. In the illustrated embodiment, the welding power source 52 is a constant voltage power source that is capable of GMAW and GMAW pulse.

The welding robot 54 may be configured in a variety of ways. For example, the reach, or area that the welding robot 54 can access, the payload, or weight-carrying capacity of the welding robot 54, and the speed of the welding robot 54 are considerations used in configuring the welding robot 54. Welding robots typically have multiple movable components to provide sufficient degrees of freedom to allow the welding robot to position a welding torch 70 as required to achieve a quality weld. In the illustrated embodiment, the welding robot 54 include a base 57 configured to swivel about a vertical axis A, a first arm 58 pivotably attached to the base 57 to pivot about a first pivot axis 60, a second arm 62 pivotably attached to a distal end of the first arm 58 to pivot about a second pivot axis 64, and a third arm 66 pivotably attached to a distal end of the second arm 62 to pivot about a third pivot axis 68. The welding torch 70 is attached to a distal end of the third arm 66.

The illustrated welding system 50 includes a wire feeder 72 configured to supply weld wire to the welding torch 70 for the welding process. The wire feeder 72 may be any suitable wire feeding device. In the illustrated embodiment, the wire feeder 72 includes a pair of drive rolls 74 between which weld wire is drawn. The wire feeder 72 may be mounted to a bracket 76 that allows the wire feeder 72 to be mounted onto the welding robot 54 and provides insulation between the wire feeder 72 and the welding robot 54.

A weld wire holder 78 may be mounted to the welding robot 54 to supply hulk weld wire to the wire feeder 72 for consumption in the welding process. Typical weld wire holders 78 are either a spool-type or a barrel. A weld wire conduit 80, may be provided between the wire feeder 72 and the welding wire holder 78 to allowing the weld wire to travel to the wire feeder 72. The type and size of the weld wire being used in the welding process may vary in different embodiments. The type of weld wire and the size of the weld wire used. may depend on the type of Inconel alloy and stainless steel alloy being used. In the illustrated embodiment, the weld wire is made of Inconel 625 alloy or other suitable Inconel alloy and the weld wire has a diameter in the range of 0.025 inches (0.635 mm) to 0.045 inches (1.14 mm), or 0.030 inches (0.762 mm) to 0.035 inches (0.889 mm). In one exemplary embodiment, the wire feeder 72 is configured to feed an Inconel weld, wire, having a diameter in the range of 0.025 inches (0.635 mm) to 0.045 inches (1.14 mm) at a rate in the range of 3 m/min to 9 m/min, or 4 m/min to 8 m/min, or 6 m/min.

The welding power source 52 is in communication with the welding robot 54 via a wire/tube package 82. The wire/tube package 82 includes the electrical wires for transferring electrical power to the welding torch 70 for welding and may also include other wires and hoses, such as for example, a communication line to the wire feeder 72, coolant lines, and a shielded gas hose. In GMAW, an inert shielding gas is routed to the welding torch 70 via a shielded gas hose to protect the weld pool from atmospheric contamination.

The welding power source 52 may include an interface 84 that allows the robot controller 56 and the welding power source 52 to communicate. For example, the interface 84 may monitor weld performance and modify robot weaving, power source settings, robot speed, and many other parameters that affect weld quality. Any suitable type of interface communication may be used, such as for example, discrete, bus protocol, and Ethernet-based. The interface 84 may also include a user-interface allowing a user to input information and monitor the welding process. An interface communication cable 86 connects the welding power source 52 to the robot controller 56.

The robot controller 56 is configured to control the welding power source 52, the wire feeder 72, the welding robot 54, the welding torch 70, and various ancillary components of the welding system 50. The robot controller 56 may be configured in a variety of ways. The robot controller 56 may embody a single processor or multiple processors configured for controlling the welding robot 54 and welding process. A person of ordinary skill in the art will appreciate that the robot controller 56 may additionally include other components and may also perform other functions not described herein. The robot controller 56 may also be configured to receive inputs from an operator via the interface 84.

In the exemplary embodiment, the robot controller 56 may include a memory 88 that includes information regarding one or more parameters of the welding system 50. Further, the robot controller 56 may be configured to refer to the information stored in the memory 88. The memory 88 may also be configured to store various information determined by the robot controller 56. In some embodiments, the memory 88 may be integral to the robot controller 56. The memory 88 may be any suitable memory, such as for example, a read only memory (ROM) for storing a program or programs, a random access memory (RAM) which serves as a working memory area for use in executing the program(s) stored in the memory 88, or a combination thereof.

The program or programs may include welding software that provides the means to communicate to the welding power source 52 and to interpret the need for motion changes to optimize the welding process. The welding software may also include set points for various welding parameters for the welding process, such as for example, the voltage and the amperage used during welding, the weld wire feed rate, the torch travel speed across the area being welded. the torch position relative to the surfaces being welded (e.g., the angle of the torch relative to the welding plane), and any other welding parameter suitable for inclusion in the welding software, as desired. In some embodiments, the torch travel speed across the area being welded is in the range of 0.4 m/min. to 0.8 m/min., or 0.5m/min. to 0.7 m/min., or 0.6 m/min.

While suitable values for various welding parameters for welding stainless steel to stainless steel are well know and included in the software for many robot welders, welding parameters for welding a thin-walled Inconel component to a thicker stainless steel component, using a GMAW robotic welder, are not conventionally known. In wire feed welding, the amount of wire protruding from a distal end of the welding torch 70 is important, and the wire feed rate must be matched with the amperage and voltage being used and controlled to maintain proper protrusion of the weld wire from a distal end of the welding torch 70 to generate a quality weld. Inconel has a greater resistivity to electrical current than stainless steel. Thus, for a given thickness of a component, the set-points used for key welding parameters for welding stainless steel to stainless steel, such as amperage, voltage, and wire feed rate, are not suitable for welding Inconel to stainless steel.

For example, in an attempt to MIG weld, a 1.3 mm thick Inconel 625 plate to a 4 mm stainless steel 316 plate using conventional amperage, voltage, and wire feed settings (135 amps, 22 volts, 6 m/min feed rate) for welding stainless steel components of these thicknesses, the welding torch essentially functioned as a plasma cutter and cut through the plates.

One of skill in the art, when faced with the above scenario, would tend to lower the amperage in order to, essentially, reduce the heat being delivered by the torch to the weld joint. Counterintuitive to this approach, in an exemplary embodiment of the disclosed welding process, the amperage is increased from 135 amps to over 225 amps. In some embodiments, the amperage is set in the range of 225 amps to 325 amps, or in the range of 250 amps to 300 amps. In one exemplary embodiment, the amperage is set in the range of 250 amps to 275 amps, or 265 amps. In some embodiments, however, the range of amperage may be from 100 amps to 400 amps, depending on the thickness of the material.

In conjunction with the exemplary amperage ranges disclosed above, the weld wire feed rate was maintained at about 6 m/min. and the voltage used was in the range of 9 volts to 30 volts. For example, in some exemplary embodiments, the voltage was decreased to a range of 14 volts to 20 volts, or 15.5 volts to 17.5 volts, or 16 volts to 17 volts. In some embodiments, depending on the diameter of the weld wire, the weld wire feed rate may be in the range of 3 m/min. to 9 m/min. and the voltage may be in the range of 14 volts to 30 volts.

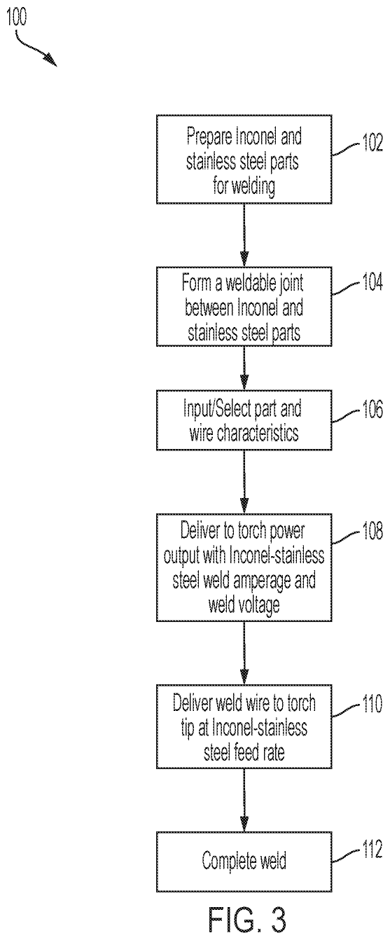

Referring to FIG. 3, a flow chart of an exemplary welding method 100 for welding a thin walled Inconel part 12 to a thicker stainless steel part 14 is illustrated. The welding method 100 includes a step of preparing the Inconel part 12 and the stainless steel part 14 to be welded 102. Preparing the Inconel part 12 and the stainless steel part 14 to be welded includes base metal cleaning and joint preparation, including selecting the appropriate and desired joint design. For example, cleaning of the materials can be done mechanically with a stainless steel wire brush and/or chemically to dissolve oxides on the surface of the materials.

The welding method 100 also includes the steps of selecting an Inconel-stainless steel weld amperage 104 (i.e., the level of current to be supplied by the welding power source 52), selecting an Inconel-stainless steel weld voltage 106 (i.e., the level of voltage to be supplied by the welding power source 52), and selecting a weld wire feed rate 108 for the Inconel weld wire during welding. Selecting each of the Inconel-stainless steel weld amperage, the Inconel-stainless steel weld voltage, and the weld wire feed rate may involve, for example, manually inputting these desired values into the interface 84 of the welding system 50 or programming the welding software of the robot welding system 50 to utilize these values when welding an Inconel 625 alloy part having the thickness T1 to a stainless steel 316 alloy part having the thickness T2,

For example, one or more variables may be selected or inputted into the interface 84, such as metal type, part thickness at the weld, weld wire material type, weld wire diameter, or other welding parameters. The welding software may then access information stored in memory, such as for example, via a look-up table, to provide the appropriate welding amperage, welding voltage, and weld wire feed rate for welding the components.

In one exemplary embodiment, a stainless steel 316 part having a thickness in the range of 3 mm to 5 mm is welded to an Inconel 625 part having a thickness in the range of 0.75 mm, to 2 mm. An Inconel 625 alloy weld wire having a diameter in the range of 0.030 inches (0.762 mm) to 0.035 inches (0.889 mm) is used. The welding, power source 52 is configured to provide an electrical output having a current in the range of 250 amps to 300 amps and a voltage in the range of 20 volts or less. The wire feeder 72 is configured to feed welding wire at a rate of 4 m/min. to 8 m/min.

Once the welding system 50 is configured with the appropriate welding parameters, such as the Inconel-stainless steel weld amperage, the Inconel-stainless steel weld voltage, and the weld wire feed rate, and the Inconel part 12 and the stainless steel part 14 are positioned to be welded (i.e., surfaces to be welded placed adjacent each other), the robotic welding system 50 can be activated to perform and complete the weld.

### INDUSTRIAL APPLICABILITY

The novel welding method of welding a thin-waned Inconel component to a thicker stainless steel component, using a robotic welder, may be used in a variety of applications in which the use of an Inconel component welded to a stainless steel component would be beneficial. One exemplary application is with an EGR cooler.

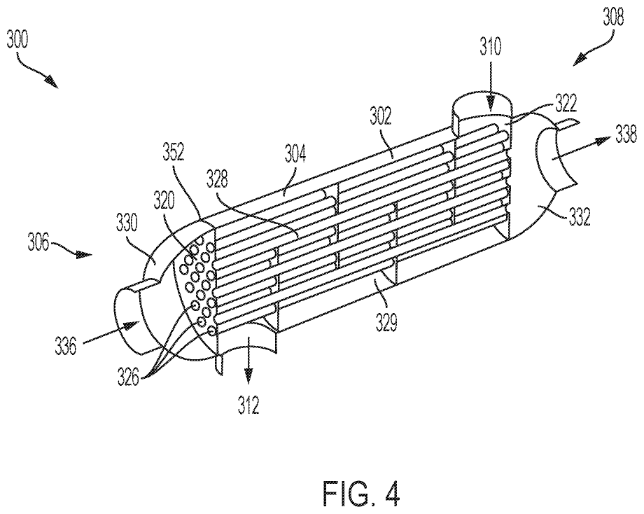

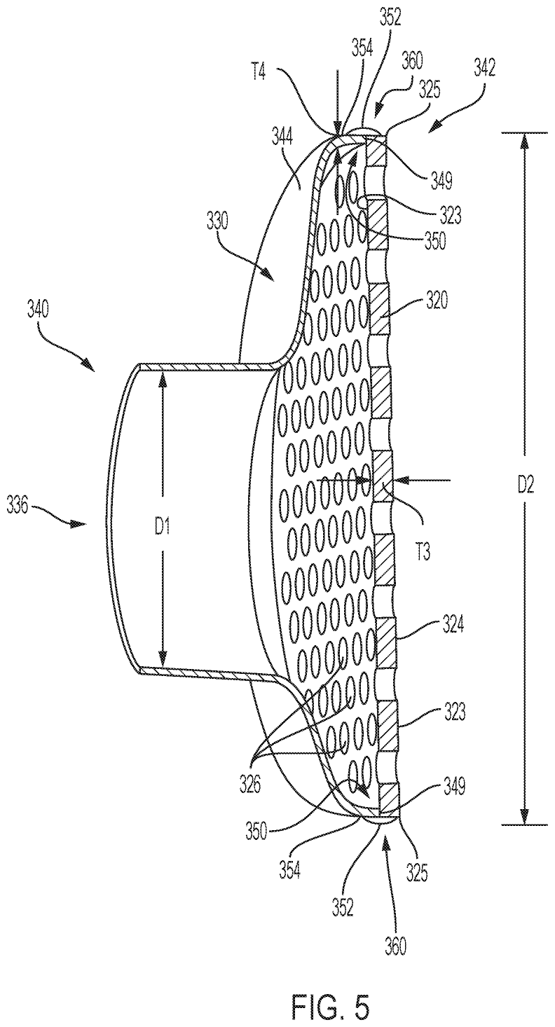

EGR coolers operate in a corrosive environment that exposes the EGR coolers to significant thermal loading and cycling. EGR coolers may be configured in a variety of ways. Any heat exchanging device that can be used in an EGR system of an engine to sufficiently reduce the temperature of the exhaust gas being, returned to the engine cylinders, while withstanding the harsh environment the EGR cooler is exposed to, may be used. FIGS. 4-5 illustrate an exemplary EGR cooler 300. The EGR cooler 300 is illustrated as a shell and tube heat exchanger, but other types of heat exchangers, such as a plate-type heat exchanger, may be used. The EGR cooler 300 includes an elongated, hollow, stainless steel body 302 having a cylindrical outer side surface 304, a first end 306, and a second end 308 opposite the first end 306. In the exemplary embodiment, the body 302 is made of stainless steel 316, but in other embodiments, other stainless steel alloys may be used. to make the stainless steel body 302.

The EGR cooler 300 includes a coolant inlet port 310 extending through the cylindrical outer side surface 304 to allow coolant to flow into the hollow interior of the body 302 and a coolant outlet port 312 extending through the cylindrical outer side surface 304 to allow coolant to flow out of the hollow interior of the body 302.

The first end 306 includes a first, circular end plate 320 and the second end 308 includes a second circular end plate 322 substantially similar to the first circular end plate 320. The first and second end plates 320, 322 are made of stainless steel, such as the same stainless steel alloy that is used for the body 302. The first end plate 320 has a first side face 323, a second side face 324 opposite and parallel to the first side face 323, and an end face 325 extending perpendicularly between the first side face 323 and the second side face 324. The first end plate 320 has a thickness T3. In one exemplary embodiment, the thickness T3 is in the range of 3 mm to 5 mm. In the exemplary embodiment, the second end plate 322 has a thickness (not shown) that is the same as the thickness T3 of the first end plate 320.

Each of the first end plate 320 and the second end plate 322 have a plurality of holes 326 extending in the thickness direction. Each of the plurality of holes 326 in the first end plate 320 align with a corresponding one of the plurality of holes 326 in the second end plate 322 to form a pair of aligned holes 326. Each of the pair of aligned holes 326 have a stainless steel tube 328 associated. therewith such that the EOR cooler includes a plurality of stainless steel tubes 328. in particular, each stainless steel tube 328 is mounted on one end into one of the holes 326 in the first end plate 320 and is mounted on the other end to the aligned one of holes 326 in the second end plate 322 such that each of the stainless steel tubes 328 extends through the elongated, hollow, body 302. The EGR cooler 300 may also include a plurality of flow baffles within the hollow interior of the body 302 to create a tortuous path for the coolant flowing through the body 302 from the coolant inlet port 310 to the coolant outlet port 312.

The EGR cooler 300 includes an Inconel diffuser 330 welded onto the first end plate 320 by the disclosed method. The EGR cooler 300 includes a collector 332 welded onto the second end plate 322, In the illustrated embodiment, the collector 332 is made of stainless steel, rather than Inconel, but otherwise is substantially the same as the Inconel diffuser 330. Thus, the description of the Inconel diffuser 330 applies equally to the collector 332. In other embodiments, however, the collector 332 may differ from the Inconel diffuser 330 or may be made from Inconel as well.

The Inconel diffuser 330 defines a gas inlet 336 opening to the EGR cooler 300 and the collector 332 defines a gas outlet 338 from the EGR cooler 300. The Inconel diffuser 330 may be made of any suitable Inconel alloy. In the illustrated embodiment, the Inconel diffuser 330 is made from Inconel 625 alloy, The Inconel diffuser 330 includes an inlet end 340 defining the gas inlet 336 and having an inlet diameter D1 and an outlet end 342, opposite the inlet end 340, defining a circular outlet having an outlet diameter D2. In the illustrated embodiment, the first end plate 320 has a diameter equal to the outlet diameter D2. In other embodiments, however, the diameter of the first end plate 320 may differ from the outlet diameter D2.

The Inconel diffuser 330 includes a thin-walled, outward flaring body 344 having a wail thickness T4. In the illustrated embodiment, the outlet diameter D2 is greater than the inlet diameter D1. For example, the inlet diameter D1 may be in the range of 25% to 50% of the outlet diameter D2, such as for example 30% to 40% of the outlet diameter D2.

In the illustrated embodiment, the outlet end 342 of the Inconel diffuser 330 has an end, face 349 that abuts, or is adjacent to, an outer peripheral surface 350 of the stainless steel first end plate 320 to form a weldable joint. The outer peripheral surface 350 may be the end face 325 or, as shown in the embodiment of FIG. 5, an outer portion of the first side face 323.

In the illustrated embodiment, the outlet end 342 of the Inconel diffuser 330 has an outer surface 354 that is coplanar, or nearly coplanar, with the end face 325 of the stainless steel first end plate 320. The Inconel first diffuser 330 and the stainless steel first end plate 320 are welded in the position such that a weld bead 352 is formed over the interface between the outlet end 342 of the Inconel first diffuser 330 and the outer peripheral surface 350 of the stainless steel first end plate 320. The weld bead 352 extends around the entire circumference of the interface between the outlet end 342 of the Inconel first diffuser 330 and the stainless steel first end plate 320 to form a welded joint 360.

During manufacturing of the EGR cooler 300, the second end 342 of Inconel diffuser 330 is welded to the stainless steel first end plate 320 of the body 302 by a robot welder utilizing the disclosed welding method.

Unless otherwise indicated herein, all sub-embodiments and optional embodiments are respective sub-embodiments and optional embodiments to all embodiments described herein. While the present disclosure has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the present disclosure, in its broader aspects, is not limited to the specific details, the representative compositions or formulations, and illustrative examples shown and described. Accordingly, departures may be made from such details without departing from the spirit or scope of Applicant's general disclosure herein.

### LIST OF ELEMENTS

Element Element

Number Name

10 welded joint

12 Inconel part

14 stainless steel part

16 first side face

18 second side face

20 end face

26 first side face

28 second side face

30 end face

32 weld bead

50 welding system

52 welding power source

54 welding robot

56 robot controller

57 base

58 first arm

60 first pivot axis

62 second arm

64 second pivot axis

66 third arm

68 third pivot axis

70 welding torch

72 wire feeder

74 drive rolls

76 bracket

78 weld wire holder

80 weld wire conduit

82 wire/tube package

84 interface

86 interface communication cable

88 memory

100 method

102 step

104 step

106 step

108 step

110 step

112 step

300 EGR cooler

302 stainless steel body

304 outer side surface

306 first end

308 second end

310 coolant inlet port

312 coolant outlet port

320 end plate

322 second end plate

326 holes

328 stainless steel tube

330 Inconel diffuser

340 collector

336 gas inlet

338 gas outlet

340 inlet end

342 outlet end

344 outward flaring body

350 outer edge

352 weld head

354 outer surface

360 welded joint

What is claimed is:

1. A method of gas metal arc welding (GMAW) an Inconel part to a stainless steel part using a welding system having a constant voltage welding power source, the method comprising:
forming a weldable joint between a first surface of the Inconel part having a first thickness and a second surface of a stainless steel part, having a second thickness at the weldable joint that is greater than the first thickness;
welding the Inconel part to the stainless steel part along the weldable joint with the welding torch;
delivering an output from the welding power source to the welding torch during welding, wherein the output of the welding power source is in the range of 100 amps to 400 amps and in the range of 14 volts to 30 volts;
delivering a continuous weld wire to a contact tip of the welding torch during welding, wherein a feed rate of the weld wire is in the range of 3 m/min. to 9 m/min.

2. The method of claim 1, wherein the Inconel part includes Inconel 625 alloy and the stainless steel part includes stainless steel 316 alloy.

3. The method of claim 2, wherein the weld wire is an Inconel alloy.

4. The method of claim 3, wherein the weld wire has a diameter in the range of 0.025 inches (0.635 mm) to 0.045 inches (1.14 mm).

5. The method of claim 2, wherein the first thickness is less than the 35% of the second thickness,

6. The method of claim 5, wherein the output of the welding power source is greater than 250 amps and less than 20 volts, and wherein the weld wire diameter is in the range of 0.025 inches (0.635 mm) to 0.045 inches (1.14 mm) and the second thickness is in the range of 3 mm to 5 mm.

7. A. robotic, gas metal arc welding (GMAW) system, comprising:
a welding robot including a welding torch and a weld wire feeder configured to deliver a continuous weld wire to a contact tip of the welding torch during welding;
a welding power source in communication with the welding robot to provide a power output to the welding torch and with the weld wire feeder to provide power to the weld wire feeder; and
a robot controller in communication with the power source and the welding robot, the robot controller configured to:
control the power source to deliver an output to the welding torch, during welding an Inconel part having a first thickness to a stainless steel part having a second thickness, that is in the range of 100 amps to 400 amps and in the range of 14 volts to 30 volts; and
control the weld wire feeder during welding the Inconel part to the stainless steel part to deliver the weld wire to the distal tip of the welding torch at a feed rate in the range of 3 m/min. to 9 m/min.

8. The robotic welding system of claim 7, wherein the Inconel part includes Inconel 625 alloy and the stainless steel part includes stainless steel 316 alloy.

9. The robotic welding system of claim 8, wherein the weld wire is an Inconel alloy,

10. The robotic welding system of claim 9, wherein the weld wire has a diameter in the range of 0.025 inches (0.635 mm) to 0.045 inches (1.14 mm).

11. The robotic welding system of claim 8, wherein the first thickness is less than the 50% of the second thickness.

12. The robotic welding system of claim 8, wherein the first thickness is less than the 35% of the second thickness.

13. The robotic welding system of claim 12, wherein the second thickness is in the range of range of 3 mm to 5 mm and wherein the output of the welding power source is greater than 250 amps and less than 20 volts, and wherein the weld wire diameter is in the range of 0.025 inches (0.635 mm) to 0.045 inches (1.14 mm).

14. The robotic welding system of claim 7, wherein the robot controller is configured to control the power source and weld wire feeder in response to receiving input from a user regarding the type of Inconel alloy used for the Inconel part, the type of stainless steel alloy used for the stainless steel part, the type of Inconel alloy used for the weld wire, the thickness of the Inconel part, the thickness of the stainless steel part, and the diameter of the weld wire.

15. A method of gas metal arc welding (GMAW) an Inconel diffuser to a stainless steel end plate of an EGR cooler using a welding system having a welding power source, the method comprising:
forming a weldable joint between an end surface of the Income diffuser and a peripheral surface of the stainless steel end plate, wherein the Inconel end surface has a first thickness and the steel plate has a second thickness that is greater than the first thickness at the weldable joint;
welding the Inconel diffuser to the stainless steel end plate along the weldable joint with the welding torch;
delivering an output from the welding power source to the welding torch during welding, wherein the output of the welding, power source is in the range of 100 amps to 400 amps and in the range of 14 volts to 30 volts;
delivering a continuous weld wire to a contact tip of the welding torch during welding, wherein a feed rate of the weld wire is in the range of 3 m/min. to 9 m/min.

16. The method of claim 15, wherein the Inconel diffuser includes Inconel 625 alloy and the stainless steel end plate includes stainless steel 316 alloy.

17. The method of claim 16, wherein the weld wire is an Inconel alloy.

18. The method of claim 17, wherein the weld wire has a diameter in the range of 0.025 inches (0.635 mm) to 0.040 inches (1.016 mm).

19. The method of claim 16, wherein the first thickness is less than the 35% of the second thickness.

20. The method of claim 19, wherein the output of the welding power source is greater than 250 amps and less than 20 volts, and wherein the weld wire diameter is in the range of 0.025 inches (0.635 mm) to 0.045 inches (1.14 mm) and the second thickness is in the range of 3 mm to 5 mm.
